(19) United States
(12) Patent Application Publication
(10) Pub. No.: US 2009/0069929 A1
(43) Pub. Date: Mar. 12, 2009

(54) SYSTEM AND METHOD FOR CREATING CUSTOMIZED MULTI-MEDIA GREETING CARDS VIA A KIOSK

(76) Inventors: Truc Nguyen, San Diego, CA (US); Mike Yeung, Mission Viejo, CA (US); John X. Garred, Brecksville, OH (US); Susan L. Mizer, Twinsburg, OH (US); Emily Tucker, Los Angeles, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/851,972

(22) Filed: Sep. 7, 2007

(51) Int. Cl. G06F 17/00

(52) U.S. Cl. 700/233

(57) ABSTRACT

The subject application is directed to a system and method for creating customized, multimedia greeting cards via a kiosk. Template data, associated with greeting card templates, and multimedia data files are first stored in an associated data storage. Indicia are then generated on an associated display corresponding to the greeting card templates. Selection data is received corresponding to a selected greeting card template and a multimedia file is associated with the selected greeting card template. Customization data corresponding to user selected content associated with the selected greeting card template is then received. A greeting card output is thereafter generated in accordance with the received selection data, customization data, and the associated multimedia data file. The greeting card output also includes a visual representation of the selected greeting card template and customization data, as well as an encoding of the multimedia data file

### BACKGROUND OF THE INVENTION

The subject application is directed generally to shared document output devices, such as kiosks, for generating tangible documents. It is particularly suited to greeting card kiosks that allow users to generate greeting cards inclusive of multimedia content.

Kiosks, such as custom greeting card kiosks, are becoming increasingly popular. Such kiosks eliminate cost and floor space associated with stocking and displaying a large variety of greeting cards. A typical kiosk will employ a computer having a memory for storing card design options, as well as a user interface such as a touch screen, display, keyboard, or pointing device. A printer will generate a tangible card in accordance with user selections. There is also typically included a mechanism by which payment for producing a selected card is made.

Kiosks allow for customization of card design or content, as well as a means to fill a demand for infrequently remembered but important occasions, such as less popular religious holidays or other non-religious occasions. Finally, kiosks allow for electronic updating of card options or designs without loss of inventory or time for replacement.

While kiosks are advantageous for the reasons noted above, they are nonetheless constrained to printed, visual content.

### SUMMARY OF THE INVENTION

In accordance with one embodiment of the subject application, there is provided a system and method directed to shared document output devices for generating tangible documents.

Further, in accordance with one embodiment of the subject application, there is provided a system and method for the generation of greeting cards inclusive of multimedia content.

Still further, in accordance with one embodiment of the subject application, there is provided a system for creating customized multi-media greeting cards via a kiosk. The system comprises a data storage including means adapted for storing template data associated with a plurality of greeting card templates and storing a plurality of multimedia data files. The system also comprises means adapted for generating, on an associated display, indicia corresponding to the plurality of greeting card templates and means adapted for receiving selection data corresponding to at least one selected greeting card template from the plurality thereof. The system further includes association means adapted for associating at least one multimedia data file with the at least one selected greeting card template and means adapted for receiving customization data corresponding to user-selected content associated with the at least one selected greeting card template. The system further comprises means adapted for generating a greeting card output in accordance with received selection data, received customization data, and the at least one associated multimedia data file, wherein the greeting card output includes a visual representation of a selected greeting card template and received customization data, and an encoding of the at least one multimedia data file.

In one embodiment of the subject application, the system includes means adapted for receiving multimedia selection data corresponding to a selection of the least one multimedia data file associated with the at least one selected greeting card template.

In another embodiment of the subject application, the encoding of the at least one multimedia data file is comprised of a tangible digital encoding disposed in at least one of a multidimensional bar code, optically encoded file, magnetically encoded file and binary memory storage.

In yet another embodiment of the subject application, the means adapted for generating a greeting card output includes means adapted for generating the greeting card as a tangible output inclusive of means adapted for sensing a physical property thereof and means adapted for selectively enabling a playback of the digital encoding in accordance with the sensing of the physical property.

In a further embodiment of the subject application, at least one multimedia data file is comprised of at least one of audio data and video data. Preferably, the system further comprises capture means adapted for capturing the at least one multimedia data file from an associated transducer and means adapted for digitizing an output of the associated transducer, wherein the associated transducer is at least one of an audio capture device and a video capture device.

In still another embodiment of the subject application, the system also includes means adapted for selecting address data corresponding to at least one selected recipient and means adapted for routing a generated greeting card output to the at least one selected recipient in accordance with received selection data.

Further, in accordance with one embodiment of the subject application, there is provided a method for creating customized multi-media greeting cards via a kiosk in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for creating customized, multimedia greeting cards via a kiosk according to one embodiment of the subject application;

FIG. 2 is a block diagram illustrating device hardware for use in the system for creating customized, multimedia greeting cards via a kiosk according to one embodiment of the subject application;

FIG. 3 is a functional diagram illustrating the device for use in the system for creating customized, multimedia greeting cards via a kiosk according to one embodiment of the subject application;

FIG. 4 is a block diagram illustrating controller hardware for use in the system for creating customized, multimedia greeting cards via a kiosk according to one embodiment of the subject application;

FIG. 5 is a functional diagram illustrating the controller for use in the system for creating customized, multimedia greeting cards via a kiosk according to one embodiment of the subject application;

FIG. 6 is a flowchart illustrating a method for creating customized, multimedia greeting cards via a kiosk according to one embodiment of the subject application; and

FIG. 7 is a flowchart illustrating a method for creating customized, multimedia greeting cards via a kiosk according to one embodiment of the subject application.

### DETAILED DESCRIPTION OF THE PREFERRED EMBODIMENT

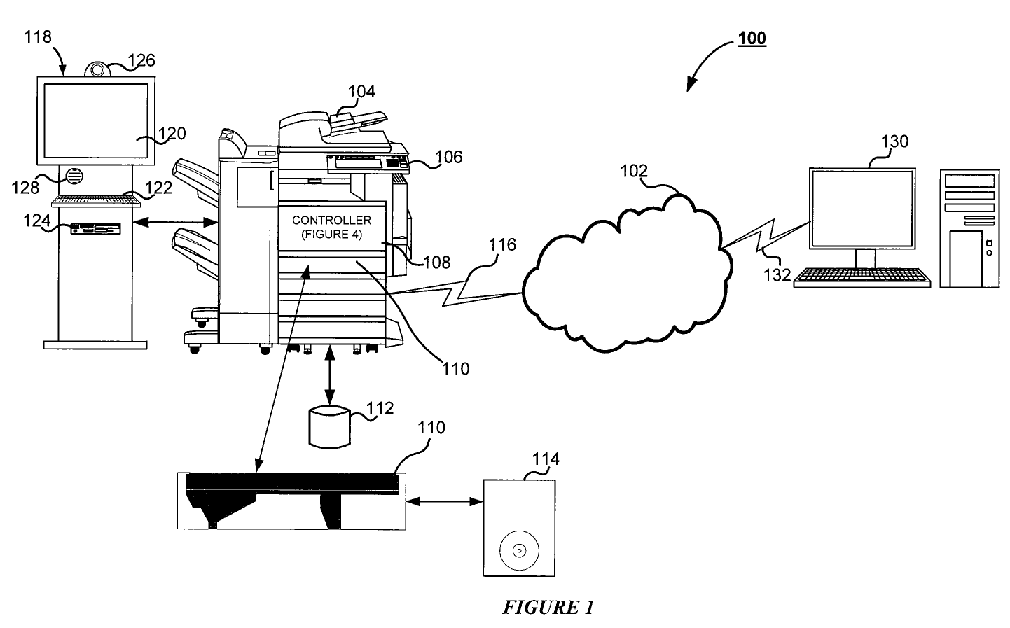

The subject application is directed to shared document output devices for generating tangible documents. In particular, the subject application is directed to a system and method for the generation of greeting cards inclusive of multimedia content. More particularly, the subject application is directed to a system and method for creating customized multimedia greeting cards via a kiosk. It will become apparent to those skilled in the art that the system and method described herein are suitably adapted to a plurality of varying electronic fields employing multimedia content, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for creating customized multimedia greeting cards via a kiosk in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

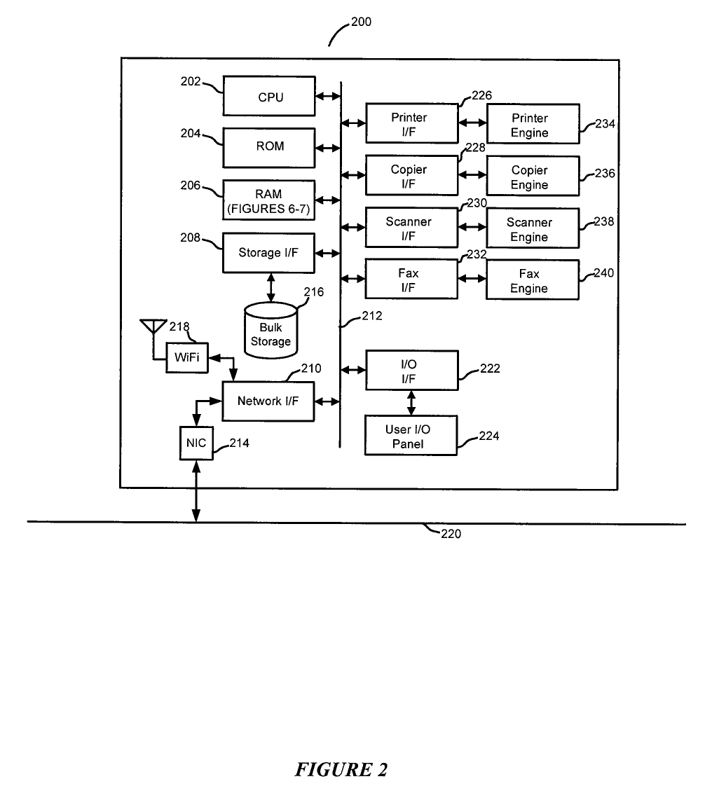

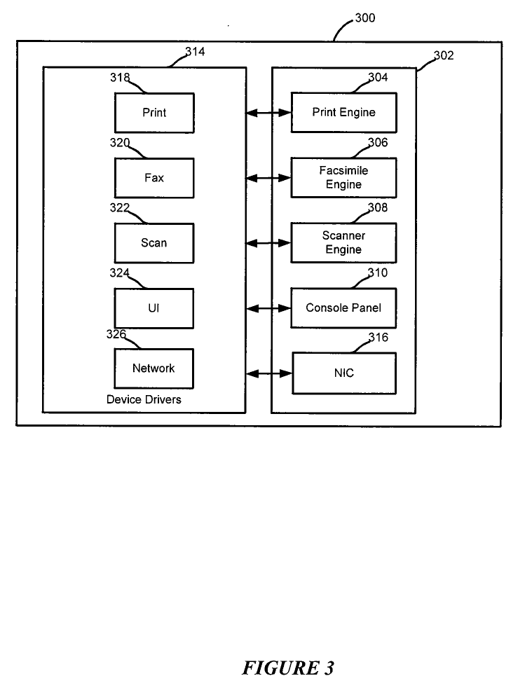

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a communications link 116. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

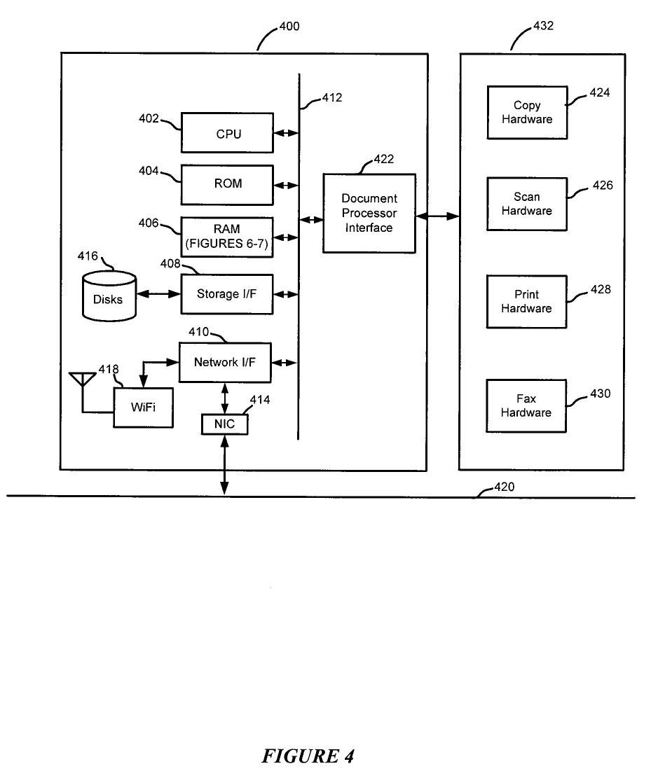

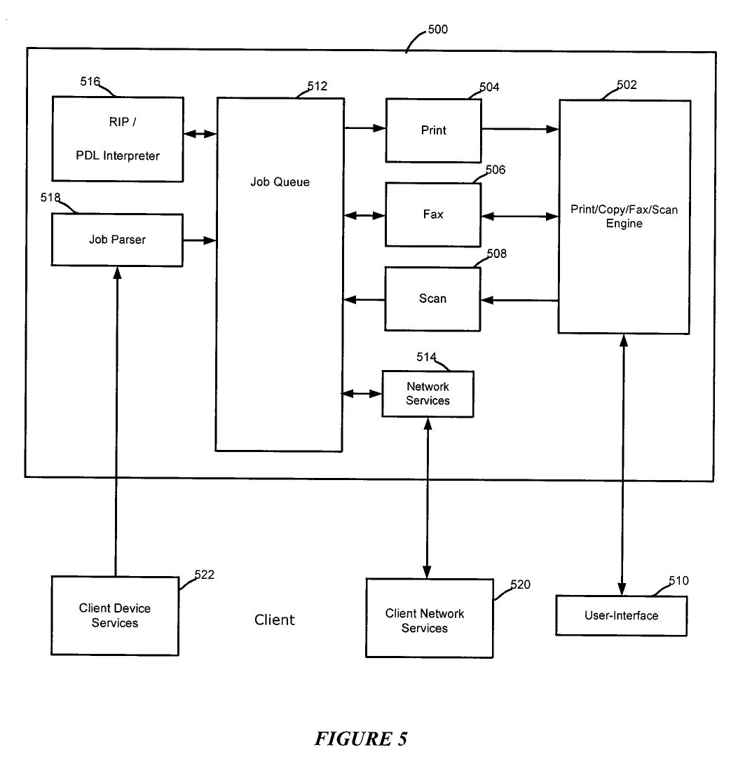

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for generating customized multimedia greeting cards via a kiosk of the subject application. The functioning of the controller 108 will better be understood in conjunction with the block diagrams illustrated in FIGS. 4 and 5, explained in greater detail below.

Communicatively coupled to the document processing device 104 is a data storage device 112. In accordance with the preferred embodiment of the subject application, the data storage device 112 is any mass storage devices known in the art including, for example and without limitation, magnetic storage drives, a hard disk drive, optical storage devices, flash memory devices, or any suitable combination thereof. In the preferred embodiment, the data storage device 112 is suitably adapted to store document data, image data, electronic database data, or the like. It will be appreciated by those skilled in the art that while illustrated in FIG. 1 as being a separate component of the system 100, the data storage device 112 is capable of being implemented as an internal storage component of the associated document processing device 104, a component of the controller 108, or the like, such as, for example and without limitation, an internal hard disk drive, or the like. In accordance with one embodiment of the subject application, the data storage device 112 is capable of storing images, greeting card formats, multimedia data files, fonts, and the like.

As depicted in FIG. 1, the document processing device 104 further includes one or more media storage trays 110, suitably configured to stored output media 114 for output by the document processing device 110. The skilled artisan will appreciate that the media storage tray 110 is representative of any of a myriad of storage components associated with the document processing device 104 capable of storing sheets of paper of varying sizes, sheets of transparencies, blank greeting cards, blank multi-media, blank CD or DVD media, blank business cards, photographic paper, envelopes, or any other output medium upon which documents or images are rendered. In accordance with one embodiment of the subject application, the output media 114 includes a recording medium suitably adapted to receive and store machine-readable data, such as audio data, video data, image data, and the like.

Illustrated in FIG. 1 is a kiosk 118, communicatively coupled to the document processing device 104, and in effect, the computer network 102. It will be appreciated by those skilled in the art that the kiosk 118 is capable of being implemented as a separate component of the document processing device 104, or as an integral component thereof. Use of the kiosk 118 in FIG. 1 is for example purposes only, and the skilled artisan will appreciate that the subject application is capable of implementation without the use of kiosk. In accordance with one embodiment of the subject application, the kiosk 118 includes a display 120 and a user input device 122. As will be understood by those skilled in the art the kiosk 118 is capable of implementing a combination user input device/display, such as a touch screen interface. According to one embodiment of the subject application, the kiosk 118 is suitably adapted to display prompts to an associated user, receive instructions from the associated user, receive payment data, receive selection data from the associated user, and the like. Preferably, the kiosk 118 includes a magnetic card reader, conventional bar code reader, or the like, suitably adapted to receive and read payment data from a credit card, coupon, debit card, or the like.

The system 100 of FIG. 1 also includes a portable storage device reader 124, coupled to the kiosk 118 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art. The kiosk 118 further includes an image capture device 126, depicted in FIG. 1 as a webcam. It will be appreciated by those skilled in the art that the image capture device 126 is representative of any suitable means of capturing an image or video including, for example and without limitation digital image capturing means, as are known in the art. The kiosk 118 also includes an audio capture device, illustrated in FIG. 1 as a microphone 128. In addition, the kiosk 118 is further capable of including a speaker (not shown) suitably adapted to enable the user to preview multimedia, as will be understood by those skilled in the art.

The system 100 illustrated in FIG. 1 further depicts a user device 130, in data communication with the computer network 102 via a communications link 132. It will be appreciated by those skilled in the art that the user device 120 is shown in FIG. 1 as a computer workstation for illustration purposes only. As will be understood by those skilled in the art, the user device 130 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 132 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 130 is suitably adapted to generate and transmit electronic documents, multimedia files, document processing instructions, user interface modifications, upgrades, updates, personalization data, or the like, to the document processing device 104, or any other similar device coupled to the computer network 102. In accordance with one embodiment of the subject application, the user device 130 includes a web browser application, suitably adapted to securely interact with the document processing device 104, or the like.

Turning now to FIG. 2, illustrated is a representative architecture of a suitable device 200, (shown in FIG. 1 as the document processing device 104), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, (shown in FIG. 1 as the document processing device 104), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which include the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

In operation, template data associated with a plurality of greeting card templates are stored in an associated data storage. A plurality of multimedia data files are then stored in the associated data storage. On an associated display, indicia is generated corresponding to the greeting card templates. Selection data is then received corresponding to at least one selected greeting card template. At least one multimedia file is then associated with the selected greeting card template. Customization data corresponding to user selected content associated with the selected greeting card template is then received. A greeting card output is thereafter generated in accordance with the received selection data, customization data, and the associated multimedia data file. The greeting card output also includes a visual representation of the selected greeting card template and customization data, as well as an encoding of the multimedia data file.

In accordance with one example embodiment of the subject application, a greeting card output request is received from an associated user via the kiosk 118, the user interface 106 associated with the document processing device 104, via a thin client interface associated with the user device 130, or the like. Preferably, the user selects, via a graphical user interface associated with the display 120 of the kiosk a greeting card output option, as will be understood by those skilled in the art. The controller 108, kiosk 118, or other suitable component associated with the document processing device 104 then retrieves greeting card templates from the data storage device 112. Indicia corresponding to the retrieved greeting card templates are then generated on the display 120 associated with the kiosk 118, the user interface 106 associated with the document processing device 104, or the like. It will be appreciated by those skilled in the art that the generation of indicia corresponds to the display of graphical representations of the greeting card templates on the aforementioned displays 120, 106 to the associated user.

Selection of one of the greeting cards is then received from the user via interaction with the touch screen display 120 or input device 122 associated with the kiosk 118, the user interface 106 associated with the document processing device 104, or the like. That is, the user selects one of the displayed indicia corresponding to the greeting card templates via the graphical user interface. When no multimedia file is to be attached to the greeting card, the user is prompted to select customization data corresponding to customized content of the greeting card. For example, the user is able to input a customized greeting, closing, message, or the like. The user is then prompted for output type, e.g., tangible hardcopy output, electronic mail transmission, facsimile transmission, or the like.

Upon electronic output selection, e.g., electronic mail, the user is prompted to select address data corresponding to a selected recipient of the customized greeting card. The kiosk 118, controller 108, or other suitable component associated with the document processing device 104 then calculates the costs associated with outputting the customized greeting card. Following receipt of payment from the user, a customized greeting card, inclusive of the customization data, is generated by the document processing device 104 and routed to the selected recipient via the computer network 102. The skilled artisan will appreciate that suitable payment data includes, for example and without limitation, credit card data, cash, pre-paid account, coupon, billing account, and the like.

When tangible document output is desired by the user, the controller 108 or other suitable component associated with the document processing device 104 senses the physical properties associated with the available tangible output media 114 stored in the output tray 110. Playback of a digital encoding is then selectively enabled based upon the sensed physical properties of the output media 114 and the multimedia data file, if any, selected by the user. Costs associated with the generation of the tangible hardcopy output of the customized greeting card are then calculated by the controller 108 or other suitable component associated with the document processing device 104. It will be appreciated by those skilled in the art that the costs are calculated based upon, for example and without limitation, output media selected, copyright fees, toner usage, resource requirements, colors selected, and the like. Upon receipt of payment from the user corresponding to the calculated costs, the document processing device 104 outputs a customized greeting card inclusive of the customization data.

When the user desires to include at least one multimedia data file in the customized greeting card, a determination is made whether the user desires to use a custom multimedia file. When a customized multimedia data file is not desired, the kiosk 118, controller 108, or other suitable component associated with the document processing device 104 retrieves multimedia data files from the data storage device 112 corresponding to previously stored multimedia files available of use in customized greeting card operations. In accordance with one embodiment of the subject application, the multimedia data files are stored in a suitable format for output by the document processing device 104. According to a further embodiment of the subject application, the multimedia data files retrieved are associated with the selected greeting card template. Thus, for example and without limitation, when the selected template corresponds to a birthday card, suitable multimedia data files associated with birthdays are retrieved, e.g., “Happy Birthday”, “Sixteen Candles”, lighted candles, birthday cakes, and the like. Preferably, the retrieved multimedia data files are displayed to the user via the display 120, the user interface 106, or the like. In accordance with one embodiment of the subject application, the user is able to selectively preview multimedia data files prior to the selection thereof.

Upon receipt of a selected multimedia data file from the user, the controller 108 or other suitable component associated with the document processing device 104 associates the selected multimedia data file with the selected greeting card template. Customization data corresponding to customized content for inclusion in the customized greeting card is then received from the associated user. The user is then prompted to select either tangible hardcopy output or electronic output, as set forth above. Upon selection of tangible hardcopy output, the controller 108 senses the physical properties of output media 114 to determine the type of encoding needed for inclusion of the multimedia data file on the tangible customized greeting card. For example, the output media 114 is capable of including magnetic or optical storage media, e.g., soft-CD, DVD, or the like, a multimedia player, or the like. The costs associated with outputting the tangible document are then calculated, inclusive of any copyright royalties, toner usage, color selection, output media 114, and the like. Upon payment by the user, the customized greeting card, inclusive of the selected multimedia file, is then output by the document processing device 104.

When a custom multimedia file is desired for inclusion in the customized greeting card, a determination is made whether a portable storage device has been detected by the controller 108 or other suitable component associated with the document processing device 104. That is, whether a flash memory card, USB drive, CD, DVD, or the like, has been inserted by the user into the appropriate media reader 124 of the kiosk 118. The user is also capable of creating a new, personal multimedia data file for inclusion with the greeting card via capturing multimedia data from an associated transducer, e.g., the webcam 126, microphone 128, or the like. The output of the transducer is then digitized, resulting in a suitable multimedia data file. Upon acceptance by the user of the new file, e.g., playback of the audio and/or video, the file is associated with the selected greeting card template and operations continue thereon as set forth above.

When a portable data storage device is detected, multimedia files on the device are then retrieved from the device and displayed to the user via the associated user interface 106, display 120, or the like. Upon receipt of a selected multimedia file by the user, a determination is made whether conversion of the selected file to an acceptable format is required. When conversion is required, the controller 108 or other suitable component associated with the document processing device 104 converts the multimedia file to a suitable component, e.g., WAV, MP3, MP4, WMA, and the like. Thereafter, the selected multimedia file is associated with the greeting card template and the user is prompted for customization data, as set forth above. Operations continue thereafter as set forth above.

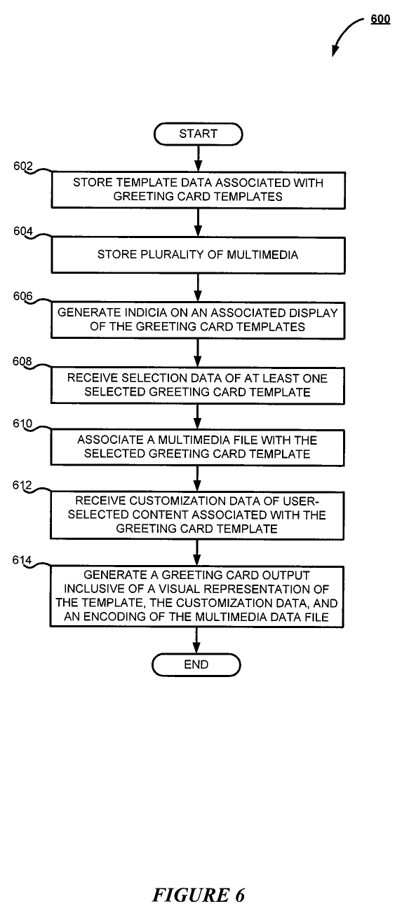

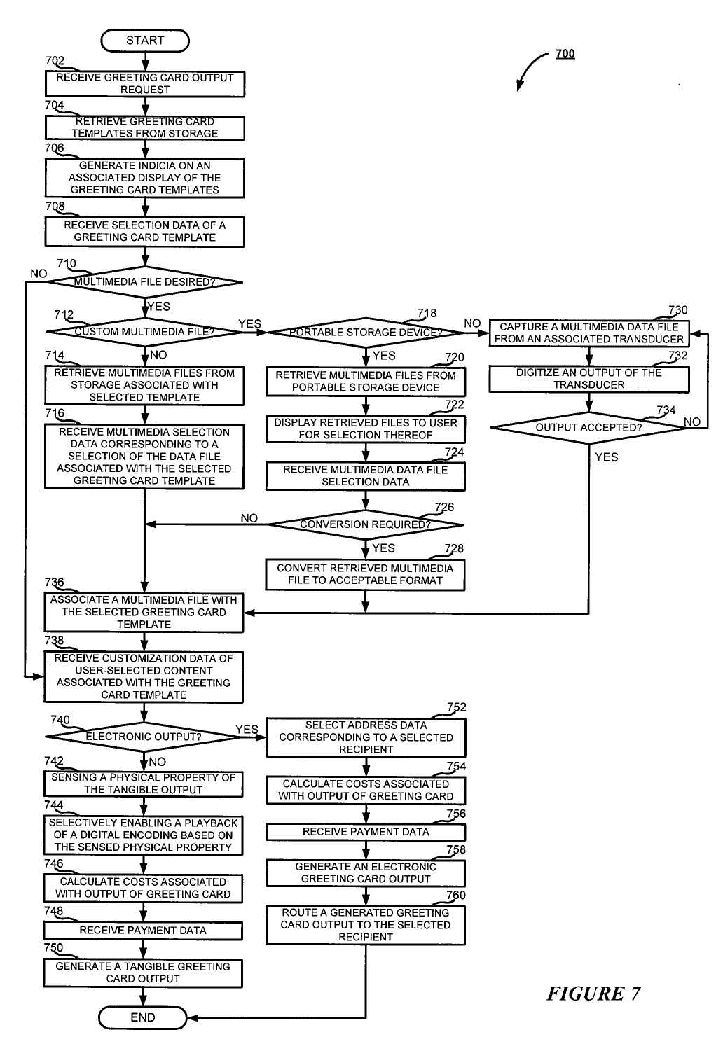

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for creating customized, multimedia greeting cards via a kiosk in accordance with one embodiment of the subject application. Beginning at step 602, template data associated with a plurality of greeting card templates are stored in an associated data storage 112. A plurality of multimedia data files are then stored in the associated data storage 112 at step 604.

At step 606, indicia are generated corresponding to the greeting card templates on an associated display. In accordance with one embodiment of the subject application, the associated display corresponds to the display of the user interface 106 associated with the document processing device 104, the display 120 associated with the kiosk 118, the thin client associated with the user device 130, or the like. It will be appreciated by those skilled in the art that the indicia suitably corresponds, for example and without limitation, to thumbnail images of greeting cards on a graphical user interface. Selection data is then received at step 608 from an associated user via the kiosk 118, the user interface 106, the user device 130, or the like, corresponding to at least one selected greeting card template. Preferably, the user selects one of the indicia generated on the associated display 106, 120, etc., corresponding to a desired greeting card template.

At step 610, at least one multimedia file is then associated with the selected greeting card template. Flow then proceeds to step 612, whereupon customization data corresponding to user selected content associated with the selected greeting card template is received via the kiosk 118, the user device 130, the user interface 106, or other suitable component associated with the document processing device 104. At step 614, a greeting card output is generated according to the received selection data, customization data, and the associated multimedia data file. Preferably, the greeting card output includes a visual representation of the selected greeting card template and customization data, as well as an encoding of the multimedia data file.

Referring now to FIG. 7, there is shown a flowchart 700 illustrating a method for creating customized, multimedia greeting cards via a kiosk in accordance with one embodiment of the subject application. The methodology of FIG. 7 begins at step 702, whereupon a greeting card output request is received from an associated user via the kiosk 118, the user interface 106 associated with the document processing device 104, via a thin client interface associated with the user device 130, or the like. In accordance with one embodiment of the subject application, the greeting card request is received via user interaction with a graphical user interface associated with the display 120 of the kiosk a greeting card output option, as will be understood by those skilled in the art.

Following receipt of a request for a greeting card operation, the controller 108, kiosk 118, or other suitable component associated with the document processing device 104 retrieves greeting card templates from the data storage device 112 at step 704. In accordance with one embodiment of the subject application, the greeting card templates correspond to blank greeting cards, or templates, upon which a user is able to incorporate customized content, multimedia, and the like. At step 706, indicia corresponding to the retrieved greeting card templates are generated on the user interface 106 associated with the document processing device 104, on the display 120 associated with the kiosk 118, or the like. According to one embodiment of the subject application, the generation of indicia corresponds to the display of graphical representations of the greeting card templates to the associated user. Selection data is then received at step 708 corresponding to a selected greeting card from the user via interaction with the touch screen display 120 or input device 122 associated with the kiosk 118, the user interface 106 associated with the document processing device 104, or the like.

A determination is then made at step 710 whether a multimedia data file is desired to be included in the greeting card output. That is, whether the user desires to add a multimedia data file to the customized greeting card. When no multimedia data file is desired, flow proceeds to step 738, discussed in greater detail below. When a multimedia data file is desired, flow proceeds to step 712, whereupon a determination is made whether or not the user desires to use a custom multimedia file. Stated another way, the determination is made whether the user desires to use a personal file from a portable storage device, create a file using the associated webcam 126 and microphone 128 (transducers), or to use a pre-fabricated file, e.g., a file stored on the data storage device 112.

Upon a determination that a customized multimedia data file is not desired, the kiosk 118, controller 108, or other suitable component associated with the document processing device 104 retrieves multimedia data files from the data storage device 112 at step 714 corresponding to previously stored multimedia files available of use in customized greeting card operations. It will be appreciated by those skilled in the art that the multimedia data files are stored on the data storage device 112 in a suitable format for output by the document processing device 104. In accordance with one embodiment of the subject application, the multimedia data files retrieved from the data storage device 112 are associated with the selected greeting card template, e.g., when the selected template corresponds to a birthday card, suitable multimedia data files, such as songs, images, videos, graphics, and the like, associated with birthdays are retrieved. The retrieved multimedia data files are then displayed to the associated user and a selection of at least one multimedia data file is received at step 716.

The selected multimedia data file is then associated with the selected greeting card template at step 736. Customization data corresponding to customized content for inclusion in the customized greeting card is then received at step 738 from the associated user via interactions with the associated user interface 106, the display 120, the thin client of the user device 130, or the like. A determination is then made at step 740 whether the user has selected an electronic greeting card output. That is, whether the user has selected either tangible hardcopy output or electronic output.

Upon selection of tangible hardcopy output, flow proceeds to step 742, whereupon the controller 108 senses the physical properties of output media 114 to determine the type of encoding needed for inclusion of the multimedia data file on the tangible customized greeting card. For example, the output media 114 is capable of including magnetic or optical storage media, e.g., soft-CD, DVD, or the like, a multimedia player, or the like. At step 744, a playback of the multimedia data file is selectively encoded based upon the sensed physical property of the output media 114. Suitable encoding includes, for example and without limitation, multidimensional bar code, optically encoded file, magnetically encoded file, binary memory storage, and the like.

The costs associated with outputting the tangible document are then calculated at step 746, inclusive of any copyright royalties, toner usage, color selection, output media 114, and the like. Payment data is then received from the associated user at step 748 corresponding to the payment of the costs associated with the production of the customized greeting card. It will be appreciated by those skilled in the art that the costs are calculated based upon, for example and without limitation, output media selected, copyright fees, toner usage, resource requirements, colors selected, and the like. The skilled artisan will appreciate that suitable payment data includes, for example and without limitation, credit card data, cash, pre-paid account, coupon, billing account, and the like. Upon payment by the user, the customized greeting card, inclusive of the selected multimedia file, is then output by the document processing device 104 on the selected output media 114 at step 750.

Returning to step 740, upon a determination that electronic output is desired by the user, e.g., electronic mail, flow proceeds to step 752. At step 752, the user is prompted to select address data corresponding to a selected recipient of the customized greeting card. For example and without limitation, the user is prompted for an electronic mail address, a facsimile number, a storage location, and the like. The kiosk 118, controller 108, or other suitable component associated with the document processing device 104 then calculates the costs associated with outputting the customized greeting card at step 754. Payment data is then received at step 756 corresponding to the payment of the calculated costs by the user via the methods discussed above. After receipt of payment from the user, flow proceeds to step 758, whereupon a customized greeting card, inclusive of the customization data, is generated by the document processing device 104. The generated greeting card output is then routed to the selected recipient at step 760 via the computer network 102.

When it is determined at step 712 that a custom multimedia data file is desired for inclusion in the customized greeting card output, flow proceeds from step 712 to step 718. At step 718, a determination is made whether a portable data storage device is available for multimedia file retrieval. That is, whether the user has supplied a multimedia data file on a portable storage device such as, for example and without limitation, flash based memory, USB drive, optical storage, magnetic storage, and the like.

The presence of a portable data storage device, as determined at step 718, prompts the retrieval of multimedia data files from the storage device at step 720. The retrieved multimedia data files are then displayed at step 722 to the user via the associated user interface 106, display 120, the thin client associated with the user device 130, or the like. Multimedia data file selection data is then received from the associated user via the kiosk 118, the user interface 106, the user device 130, or the like, at step 724. A determination is then made at step 726 whether the selected multimedia data file requires conversion to an acceptable format. That is, whether the selected file must first be compressed, re-encoded, re-titled, or otherwise modified, to become acceptable for incorporation in the greeting card. When conversion is required, flow proceeds to step 728, whereupon the controller 108 or other suitable component associated with the document processing device 104 converts the multimedia file to a suitable format. Following conversion, or when no conversion is required, flow proceeds to step 736, whereupon the multimedia data file is associated with the selected greeting card template. Operations continue thereafter as set forth above.

Upon a determination at step 718 that no portable data storage device is detected, flow proceeds to step 730, whereupon a new, personal multimedia data file for inclusion with the greeting card is captured from an associated transducer, e.g., the webcam 126, microphone 128, or the like. The output of the transducer is then digitized, resulting in a suitable multimedia data file at step 732. A determination is then made at step 734 whether the newly created multimedia file is acceptable to the user. Preferably, a replay of the new file is displayed to the user via the user interface 106, the display 120, or the like. When the new file is not acceptable to the user, flow returns to step 730, whereupon additional data is captured. Upon acceptance by the user of the new file, e.g., playback of the audio and/or video, the file is associated with the selected greeting card template at step 736 and operations continue thereon as set forth above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A customized, multimedia greeting card kiosk system comprising:
a data storage including means adapted for storing template data associated with a plurality of greeting card templates;
the data storage including means adapted for storing a plurality of multimedia data files;
means adapted for generating, on an associated display, indicia corresponding to the plurality of greeting card templates;
means adapted for receiving selection data corresponding to at least one selected greeting card template from the plurality thereof;
association means adapted for associating at least one multimedia data file with the at least one selected greeting card template;
means adapted for receiving customization data corresponding to user-selected content associated with the at least one selected greeting card template; and
means adapted for generating a greeting card output in accordance with received selection data, received customization data, and the at least one associated multimedia data file, wherein the greeting card output includes a visual representation of a selected greeting card template and received customization data, and an encoding of the at least one multimedia data file.

2. The system of claim 1 further comprising means adapted for receiving multimedia selection data corresponding to a selection of the least one multimedia data file associated with the at least one selected greeting card template.

3. The system of claim 1 wherein the encoding of the at least one multimedia data file is comprised of a tangible digital encoding disposed in at least one of a multidimensional bar code, optically encoded file, magnetically encoded file and binary memory storage.

4. The system of claim 3 wherein
the means adapted for generating a greeting card output includes means adapted for generating the greeting card as a tangible output inclusive of means adapted for sensing a physical property thereof, and
means adapted for selectively enabling a playback of the digital encoding in accordance with the sensing of the physical property.

5. The system of claim 1 wherein at least one multimedia data file is comprised of at least one of audio data and video data.

6. The system of claim 5 further comprising:
capture means adapted for capturing the at least one multimedia data file from an associated transducer; and
means adapted for digitizing an output of the associated transducer, wherein the associated transducer is at least one of an audio capture device and a video capture device.

7. The system of claim 1 further comprising:
means adapted for selecting address data corresponding to at least one selected recipient; and
means adapted for routing a generated greeting card output to the at least one selected recipient in accordance with received selection data.

8. A method for creating customized, multimedia greeting cards via a kiosk comprising the steps of:
storing template data associated with a plurality of greeting card templates in an associated data storage;
storing a plurality of multimedia data files in the associated data storage;
generating, on an associated display, indicia corresponding to the plurality of greeting card templates;
receiving selection data corresponding to at least one selected greeting card template from the plurality thereof;
associating at least one multimedia data file with the at least one selected greeting card template;
receiving customization data corresponding to user-selected content associated with the at least one selected greeting card template; and
generating a greeting card output in accordance with received selection data, received customization data, and the at least one associated multimedia data file, wherein the greeting card output includes a visual representation of a selected greeting card template and received customization data, and an encoding of the at least one multimedia data file.

9. The method of claim 8 further comprising the step of receiving multimedia selection data corresponding to a selection of the least one multimedia data file associated with the at least one selected greeting card template.

10. The method of claim 8 wherein the encoding of the at least one multimedia data file is comprised of a tangible digital encoding disposed in at least one of a multidimensional bar code, optically encoded file, magnetically encoded file and binary memory storage.

11. The method of claim 10 wherein the step of generating a greeting card output includes generating the greeting card as a tangible output inclusive of means adapted for sensing a physical property thereof, and selectively enabling a playback of the digital encoding in accordance with the sensing of the physical property.

12. The method of claim 8 wherein at least one multimedia data file is comprised of at least one of audio data and video data.

13. The method of claim 12 further comprising the steps of:
capturing the at least one multimedia data file from an associated transducer; and
digitizing an output of the associated transducer, wherein the associated transducer is at least one of an audio capture device and a video capture device.

14. The method of claim 8 further comprising the step of:
selecting address data corresponding to at least one selected recipient; and
routing a generated greeting card output to the at least one selected recipient in accordance with received selection data.
